(19) United States
(12) Patent Application Publication
(10) Pub. No.: US 2002/0161711 A1
(43) Pub. Date: Oct. 31, 2002

(54) Fraud detection method

(76) Inventors: Karalyn K. Sartor, Shoreview, MN (US); Stephen L. Goff, Hopkins, MN (US); Timothy J. Laudenbach, Sartell, MN (US)

Correspondence Address: Beck & Tysver, P.L.L.C., Suite 100, 2900 Thomas Avenue S., Minneapolis, MN, 55416, US

(21) Appl. No.: 10/134,320

(22) Filed: Apr. 29, 2002

Related U.S. Application Data
(60) Provisional application No. 60/287,874, filed on Apr. 30, 2001.

(51) Int. Cl. G06F 17/60; H04L 9/00; H04K 1/00

(52) U.S. Cl. 705/51

(57) ABSTRACT

A method is presented for analyzing the potential that a transaction event is fraudulent utilizing the existence of multiple fraud detection rule sets. Only one rule set is applied to a particular transaction. The choice as to which rule set is to be applied is based upon the content of the transaction. For instance, in an e-commerce environment in which products can be ordered over the Internet, it may be useful to develop two separate rule sets. A first rule set, which can be weighted toward lowering false positives, is applied to all orders where the items being ordered are standard, physical products that are not easily converted to cash. A second rule set, weighted toward including more fraudulent transactions, is applied to all transactions including an order for a gift card, a stored value card, or another type of merchandise that is directly convertible to cash or is otherwise useable in a manner similar to cash.

### CLAIM OF PRIORITY

This application claims priority to provisional patent application U.S. Ser. No. 60/287,874 filed Apr. 30, 2001.

### FIELD OF THE INVENTION

This invention relates to a method for detecting fraud in an automated transaction system. More particularly, the present invention relates to an improved method of detecting fraud using multiple sets of fraud detection rules.

### BACKGROUND OF THE INVENTION

There are many existing systems for detecting fraud in the use of automated, existing credit card verification systems and other transaction systems. In many such systems, data relating to a transaction is analyzed according to numerous “rules” or “variables.” For instance, a simple fraud detection system would analyze a transaction using only two rules. An example of such a system would analyze two rules in the following context: “if more than X number of orders had been placed within the last Y hours and if the total value of the present order is over Z dollars, then the transaction should be considered potentially fraudulent.” The value of X, Y, and Z can be set according to the actual history of fraud encountered. The first rule (more than X number or orders placed in the last Y hours) is combined with the second rule (total value of the present order is over Z dollars) into a rule set. This rule set is then applied to a transaction, to determine whether the transaction is potentially fraudulent.

Once a transaction has been labeled as potentially fraudulent, several possible courses of action are available. For instance, it is possible to simply suspend or cancel all transactions that are labeled potentially fraudulent. Alternatively, potentially fraudulent transactions can be set aside for personal review by an individual. Regardless of the actual behavior that is initiated by labeling a transaction as potentially fraudulent, it is important to catch as many fraudulent transactions without the occurrence of “false-positives” dragging down the efficiency and usability of the system. There is an inherent conflict between these two desires. A single system may maximize the percentage of detected fraudulent transactions to the detriment of the number of false positives created. A competitive system may have the opposite effect.

A variety of systems have been proposed to develop an ideal rule set that would both increase the likelihood that fraudulent transactions are discovered while decreasing the incidence of false-positives. For instance, U.S. Pat. No. 5,819,226, issued to Gopinathan on Oct. 6, 1998, presents a fraud-detection system that utilizes a neural network to develop an interrelated set of “variables” based upon an analysis of prior transactions. The rule set developed under the '226 patent can include numerous rules, with rules being weighted based upon the interrelationship between rules that was discovered by the neural network analysis. The application of the rule set to a particular transaction results in a fraud detection score, which, if a limit is exceeded, causes the transaction to be treated as potentially fraudulent.

Similarly, U.S. Pat. No. 5,790,645, issued to Fawcett et al. on Aug. 4, 1998, presents a system for automatically generating rules and rule sets. In the Fawcett patent, the rule sets are used to discover fraudulent activity in cellular telephone calls.

The problem with these prior art fraud detection systems is that they are geared toward the development and implementation of a single, ideal rule set that would maximize the discovery of fraudulent transactions while minimizing the occurrence of false-positives. This ideal is impossible, since it is always possible to alter a rule set to include more fraudulent transactions, or to exclude more false-positives. Thus, each of the rule sets generated by the prior art systems embody a particular compromise between these two goals.

### SUMMARY OF THE INVENTION

The present invention overcomes the limitations in the prior art by creating multiple rule sets to analyze transactions for possibly fraudulent activity. Only one rule set is applied to a particular transaction. The choice as to which rule set is to be applied is based upon the content of the transaction. For instance, in an e-commerce environment in which products can be ordered over the Internet, it may be useful to develop two separate rule sets. A first rule set, which can be weighted toward lowering false positives, is applied to all orders where the items being ordered are standard, physical products that are not easily converted to cash. A second rule set, weighted toward including more fraudulent transactions, is applied to all transactions including an order for a gift card, a stored value card, or another type of merchandise that is directly convertible to cash or is otherwise useable in a manner similar to cash.

### BRIEF DESCRIPTION OF THE DRAWINGS

FIG. 1 is a flow chart of a fraud detection method using the present invention.

FIG. 2 is an example first rule set used in the present invention.

FIG. 3 is an example second rule set used in the present invention.

### DETAILED DESCRIPTION OF THE INVENTION

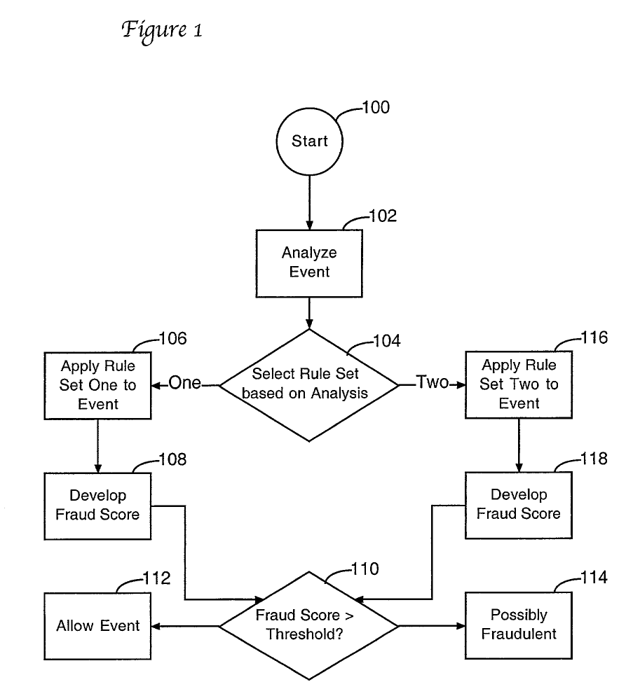

A flow chart setting forth the process 100 of the present invention is found on FIG. 1. This process 100 is designed to provide fraud detection analysis for a particular event. The event in the preferred embodiment is a e-commerce transaction order for goods via the Internet. However, it is well within the scope of the present invention to utilize the process 100 in other areas, such as traditional catalog/telephone orders, telephone usage environments, and other areas were events are analyzed to detect fraudulent transactions.

As can be seen in FIG. 1, the process 100 begins with an analysis of the event in step 102. In a preferred embodiment, the analysis is used to determine whether this is the type of event for which the fraud detection analysis should be bias toward detecting more fraudulent activity, or should be biased toward reducing false positives. In the context of e-commerce transactions, one way of analyzing an event in step 102 is to examine the content of the order. For instance, in the preferred embodiment, the products contained in the order are analyzed to determine whether they include a gift card, gift certificate, stored value card, phone card, or some other type of product that is either usable like cash or is easily transferable into cash. These types of orders have an increase risk for fraud and a decreased ability to trace the fraud after it has occurred. Thus, it is appropriate to apply a rule set to these transactions that is biased in favor of detecting more of the fraudulent transactions.

The result of the event analysis in step 102 is used in step 104 to select an appropriate rule set. Although the process 100 in FIG. 1 is shown with only two possible rule sets being selected by step 104, it would be well within the scope of the present invention to select between more than two rule sets.

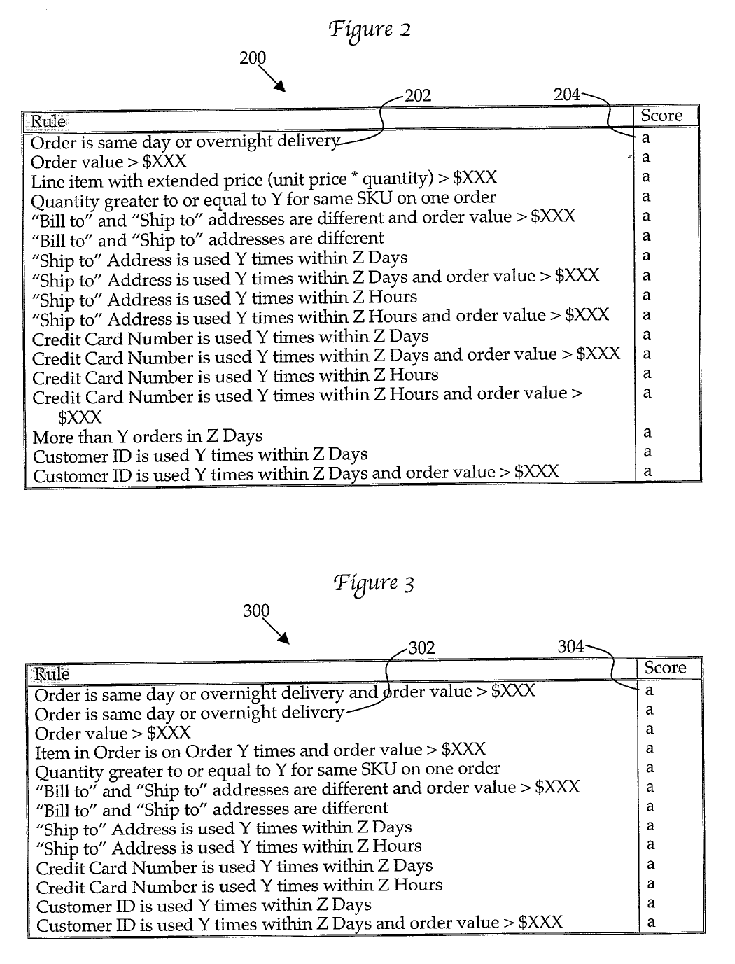

In FIG. 1, there are only two possible outcomes to step 104, namely the use of rule set one and the use of rule set two. If rule set one is to be used, step 106 applies rule set one to the event. An example rule set 200 is set forth in FIG. 2. A rule set 200 consists of at least one rule 202 that can be applied to an event to give the event some type of score 204. In FIG. 2, the first rule set 200 consists of seventeen rules 202. Each rule is a fact pattern that can exist in an event and that has some correlation to the possibility that the event is fraudulent. For instance, the first rule 202 in the rule set 200 determines whether the order is for same day or overnight delivery. The mere existence of this fact situation does not mean that the event is likely to be fraudulent. Rather, empirical evidence has shown that fraudulent transactions are more likely to include a request for same day or overnight delivery.

To apply an entire rule set 200 to an event, the event is analyzed to determine all of the rules 202 that applies to the event. Once a rule 202 is found to apply, the score 204 for the rule 202 is given to the event. If multiple rules 202 apply to the event, the scores 204 for all of the applicable rules are combined to form a fraud score for the event, which is shown in FIG. 1 as step 108. The combining of scores can be as simple as adding all of the scores 204 for all applicable rules 202. A more advance scoring method can also be used with the present invention without departing from the inventive scope of this application. For instance, the scoring mechanism could reflect the fact that some rules are interdependent, and that the applicability of two or more rules together may result in a higher score than would otherwise be applied through mere addition.

The rule set 200 in FIG. 2 is shown without absolute values shown for scores 204. Rather, each of the scores 204 is shown as a variable “a.” This indicates that the actual value 204 for a particular rule 202 is dependent upon the particular setting for the rule set 200, in light of the empirical evidence of fraud that was used to create the rule set 200. It will also be noticed that the rules 202 in rule set 200 contain variables $XXX, Y, and Z in place of absolute values. This indicates that each of these values should also be determined through empirical analysis. The use of the same variables in multiple rules is not to be taken as an indication that only one value of $XXX, Y, or Z will be applicable for every rule. Rather, the absolute values in each of these rules should be separately determined according to the empirical evidence of fraud.

Once the fraud score for an event is determined in step 108, the fraud score is compared to a threshold value in step 110 to determine how the event should be treated. The threshold value should be set according to an analysis of prior events in order to determine the level of score that indicates that an event should be treated as possibly fraudulent. If the score does not exceed the threshold value, then step 112 allows the event to be processed as a likely valid event. If the threshold value is exceeded, then step 114 handles the event as a possibly fraudulent event. As explained above, some ways of treating a possible fraudulent event range from denying the activity altogether, to requiring human, supervisory approval, to simply logging the event as requiring later analysis and allowing the event to proceed.

If step 104 selects rule set two, then rule set two is applied to the even in step 116. An example of a second rule set 300 that might be applied in this step 116 is shown in FIG. 3. Like the first rule set 200, the second rule set 300 contains numerous rules 302, each of which has an associated score 304. A comparison between FIGS. 2 and 3 shows that the two rule sets 200, 300 are similar, but involve a different number and types of rules 202, 302. This allows each of the rule sets 200, 300 to focus in on a different aspect of the event, and also allows each rule set 200, 300 to strike a different balance between covering more fraudulent transactions and decreasing false-positives.

Once the second rule set 300 is applied in step 116, a fraud score is developed in step 118. This is done in the same way as described above in step 108. This fraud score is then compared to a threshold value in step 110, as was described in connection with the application of the first rule set 200. Although FIG. 1 shows the results of step 108 and 118 both going to the same comparison step 110, it would be well within the scope of the present invention to apply the scores calculated in steps 108, 118 to different threshold values. In those cases where the threshold value is simply compared to the computed fraud score, however, it would be possible to achieve the same result using the same threshold value by simply scaling one fraud score to match the scale of the other fraud score.

The invention is not to be taken as limited to all of the details thereof as modifications and variations thereof may be made without departing from the spirit or scope of the invention.

What is claimed is:

1. A method for analyzing the likelihood of fraud in a transaction event, the method comprising:
a) analyzing the content of the event to select one of at least two different rule sets, with each rule set consisting of at least two fraud detection rules;
b) applying the rules contained in the selected rule set to the event to generate a fraud score without applying any non-selected rule sets; and
c) determining whether to treat the event as possibly fraudulent based upon the generated fraud score.

2. The method of claim 1, wherein the step of analyzing the content of the event further comprising examining the transaction event for a purchase of a product selected from the set comprised of a gift card, a gift certificate, a stored value card, and a phone card.

3. The method of claim 2, wherein the step of determining whether to treat the even as possibly fraudulent is accomplished by determining whether the generated fraud score exceeds a predetermined value.
